(19) United States
(12) Patent Application Publication
(10) Pub. No.: US 2008/0263586 A1
(43) Pub. Date: Oct. 23, 2008

(54) Method and media for virtual product placement

(76) Inventor: Keith C. Thomas, Vermillion, SD (US)

Correspondence Address: GATEWAY, INC.;ATTN: Patent Attorney, 610 GATEWAY DRIVE, MAIL DROP Y-04, N. SIOUX CITY, SD, 57049, US

(21) Appl. No.: 12/081,506

(22) Filed: Apr. 17, 2008

Related U.S. Application Data
(63) Continuation of application No. 09/472,666, filed on Dec. 27, 1999, now abandoned.

(51) Int. Cl. H04N 7/10

(52) U.S. Cl. 725/32

(57) ABSTRACT

Steps employed in editing content in moving media are used to enable virtual product placement in existing moving content, which may comprise either recorded or rendered moving images. Further, by such steps media may be created that contain virtually placed products. In addition, business methods for commercial placement of product in media may be employed that are based upon metrics parameterized according to distribution by time slot, geographic area, or distribution channel.

### BACKGROUND OF THE INVENTION

1. Field of the Invention

This invention relates to graphics applications generally, and specifically to the use of such applications in rendering product placement in media content and further to methods of doing business related thereto.

2. Description of the Related Art

Product placement is a well-known and long-standing practice in the entertainment content and production industry, in which articles of manufacture which are readily identifiable by the public, either because of distinctive trade dress or prominent trademark, are displayed within the content or the production. Though often the display of the item is merely incidental to the content or production, such product placement can have highly advantageous effect upon the perception of the product and can serve as effective advertising for the product, as was the case for Reese's Pieces in Spielberg's E. T, the Extraterrestrial.

In an area of art heretofore unrelated to the foregoing, in recent years great strides in computer hardware dedicated to computation and graphics processing, on the one hand, and great advances in computer software in image-based rendering and other software arts for creating realistic three-dimensional images, on the other hand, have made possible new ways of generating, manipulating and transforming the content of visual media. Highly believable computer rendered visual effects in Jurassic Park, The Lost World and Star Wars Episode I The Phantom Menace contribute greatly to the popularity of these films. And, in a trend beginning with Toy Story and continued in Ants and A Bug's Life, the visual content of some major motion pictures is now created entirely by computer. The potential of these powerful new tools for creating virtual images of three dimensional objects and actors is just beginning to be exploited.

### SUMMARY OF THE INVENTION

The present invention discloses the application of editing tools of the related art to enable virtual product placement in existing moving content. The present invention further discloses media in which such product placement is employed. The ability to create virtually placed products in media, in turn, enables new ways of doing business in product placement, which also are disclosed in the present invention.

It is an object of the present invention to provide a system whereby the representation of the brand of a commercial product as an item in existing moving content may be replaced with the representation of another brand for the item. It is a further object of the present invention to provide a system of metrics for selling such virtual product placement to interested parties.

### BRIEF DESCRIPTION OF THE DRAWINGS

FIG. 1 is a block diagram of the steps involved in editing of moving content such as video, film, etc.

FIG. 2 is a block diagram representing the use of paint applications to introduce static items in moving content.

FIG. 3 is a block diagram representing the use of montage to introduce dynamic items in moving content.

FIG. 4 is a block diagram representing the use of animation to introduce animated items in moving content.

FIG. 5 shows the composition of a representative scene in MPEG-4 format.

FIG. 6 shows the composition of a synthetic computer generated can in MPEG-4 format.

FIG. 7 is a diagrammatic representation of the modification of an item within a scene of moving content resulting in virtual product placement.

FIG. 8 is a diagrammatic representation of an information handling system that may be employed in implementing the present invention.

FIG. 9A is a diagrammatic representation of selling, producing and distributing product placement by time slot.

FIG. 9B is a diagrammatic representation of selling, producing and distributing product placement by geographical distribution.

FIG. 9C is a diagrammatic representation of selling, producing and distributing product placement by distribution channel.

### DETAILED DESCRIPTION OF THE PREFERRED EMBODIMENTS

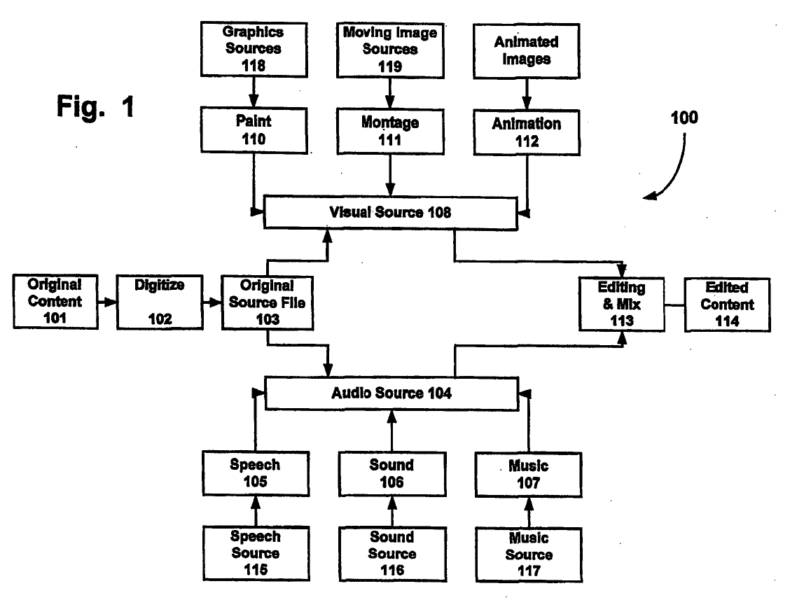

Referring now to FIG. 1, a block diagram is shown of the steps involved in editing 100 of moving content. “Moving content” herein refers to content, regardless of format or embodiment in media, that may be reproduced to display moving images and sound to a viewer. Original content 101 may comprise moving content from film. Alternatively, original content 101 may comprise moving content from a video stream such as from broadcast or cable television or from streaming video on a network such as RealVideo format from RealNetworks of Seattle, Wash. or QuickTime format from Apple Computer, Inc. of Cupertino, Calif. As another alternative, original content 101 may comprise moving content stored one of numerous file formats, such as .mov, used for storing files in the computer arts. In some embodiments, original content 101 may not even be stored or recorded but instead may be rendered as delivered to a viewer, as in many graphical computer or video games. A preferred mode of editing 100 being digital, original content 101 is digitized 102 to produce a digital source file 103 usable by digital editing process 100. One industry standard for such a digital source file 103 is the Open Media Frameworks Interchange (OMFI) file format promulgated by Avid Technology, Inc. of Tewksbury, Mass. An important characteristic of digital source file 103 is that elements of the original content are digitally referenced so that individual elements of original content 101 may be individually edited and manipulated in a non-linear fashion in digital editing process 100.

Editing of digital source file 103 comprises progressively and recursively modifying and manipulating the audio source 104 and visual source 108 originally derived from digital source file 103. Editing of digital source file 103 further comprises the addition of new sound elements 115, 116, 117 to audio source 104 and new visual elements 118, 119, 120 to visual source 108. While synchronization between audio source 104 and visual source 108 throughout editing is inherent in the digital referencing methods of modern digital editing 100, audio source 104 and visual source 108 are edited in combination and finely synchronized in the final editing and mix 113 of the content, to yield edited content 114.

Examining the processes set forth in FIG. 1 in greater detail, editing of audio source 104 further comprises editing of speech elements 105, sound elements 106 and music elements 107. Speech elements that are edited 105 comprise narration or dialog elements from source file 103 that are deleted or modified, or that are added from outside speech sources 115 as determined in editing process 100. Sound elements are edited 106 by modifying sounds from source file 103 by such techniques as employment of looping to create and insert background sounds and foley artistry to enhance sounds from source file 103. In addition, sound editing 106 comprises the addition of sound effects from outside sound sources 116 as needed. Music elements are edited 107 by musical editing and mixing techniques well known in the art, with the introduction of music elements from outside sources 117.

Similarly, conventional editing 100 of visual source 108 comprises employing “paint” application software 110 to static graphic elements of source file 103, montage techniques 111 to moving image elements of source file 103, and animation 112 to introduce animated elements 120 to source file 103. In addition, paint 110 may introduce graphic elements from outside sources 118, and montage 111 may introduce moving image elements from outside sources 119.

Editing 100 takes place progressively and recursively, with editing steps 105, 106, 107 successively applied to audio source 104 and steps 110, 111, 112 successively applied to visual source 108. Audio source 104 and visual source 108 are together subjected to successive applications of composite editing and mix 113 to assure conformity of visual source 108 and audio source 104, leading to refinement of the moving content, thus ultimately resulting in finished edited content 114.

Advantageously for the present invention, in the hands of a skilled editor this now standard form of editing allows the editor to create and replace the appearance of items in visual content by paint, montage and animation.

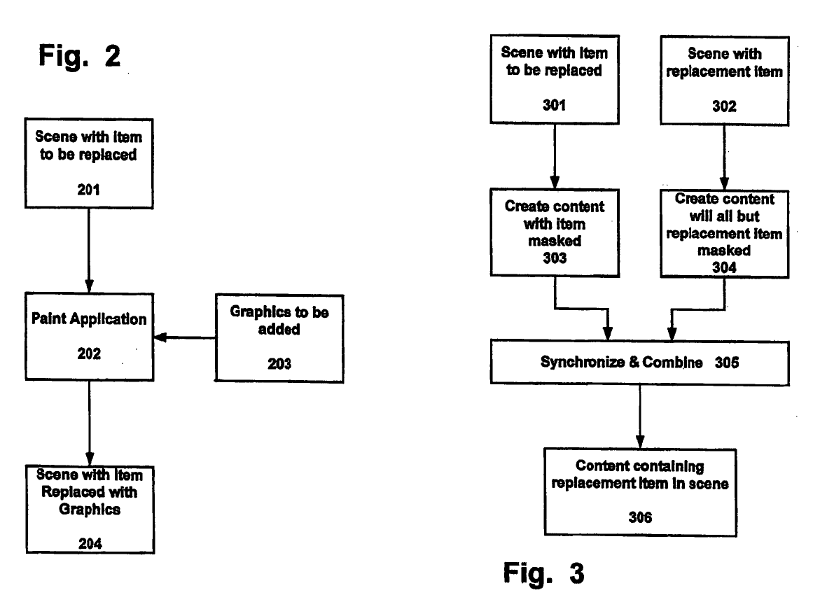

Static items in visual content may be replaced by painting directly into the content. As illustrated in FIG. 2, a scene with an item to be replaced 201 is modified by paint application 202 wherein graphics 203 are added over the item to be replaced to form a scene 204 containing the replaced item.

Dynamic items require more complex techniques to be replaced. Referring now to FIG. 3 showing montage, the content 301 containing the item to be replaced is modified to create content 303 wherein the item to be replaced is masked. In addition, content 302 is obtained containing a replacement item. Content 302 is modified to yield content 304 wherein all but the replacement item is masked. Content 303 and content 304 are combined and synchronized 305 to form content 306 containing the replacement item from content 302 within the scene from content 301.

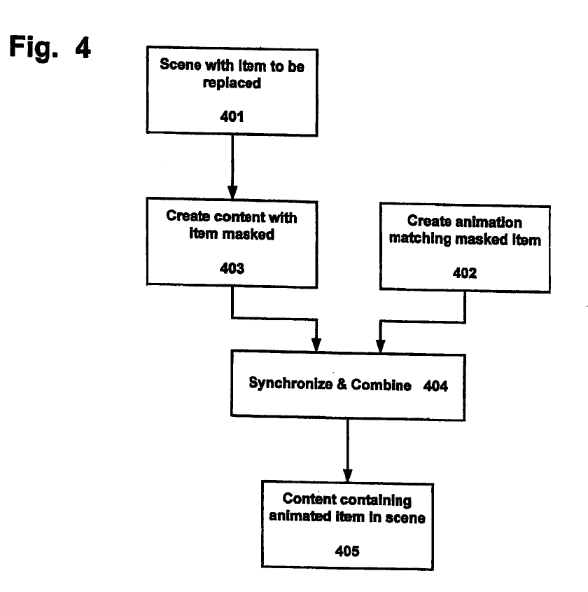

Referring now to FIG. 4 showing animation, the content 401 containing the item to be replaced is modified to create content 403 wherein the item to be replaced is masked. Animation 402 containing an animated representation of the replacement item is created to match the mask of the item to be replaced in content 403. Masked content 403 is combined and synchronized 404 with animation 402 to form content 405 containing the animated item within the scene from content 401.

Multimedia standard MPEG-4, developed by the Motion Picture Experts Group for the International Organization for Standardization, presents alternative or complementary methods for editing moving content, in particular for providing edited objects in moving content. Unlike its predecessors MPEG-1 and MPEG-2, which were essentially linear file formats for compression and transmission of moving content, MPEG-4 is a radically object-oriented paradigm. MPEG-4 is particularly suited to the production and manipulation of rendered moving content as well as recorded moving content. Within MPEG-4, audio and visual elements of moving content are known as objects. Objects can exist independently, or multiple ones can be grouped together to form higher level composite objects, referred to as “compositions”. A scene in moving content can be represented as an MPEG-4 composition of objects.

In MPEG-4, visual objects in a scene are described and projected mathematically upon the two-dimensional space which represents the two- or three-dimensional space of the scene. Similarly, consistent with such aural standards as SurroundSound®, audio objects in MPEG-4 are placed in a sound space representation of the scene. When placed in a representation of the space of the scene, in MPEG-4 the video, audio or composite object need only be defined once. As the scene vantage point and the position of an object in moving content change over time, calculations and operations to update the display and sound are performed and executed so as to render the object properly in the scene.

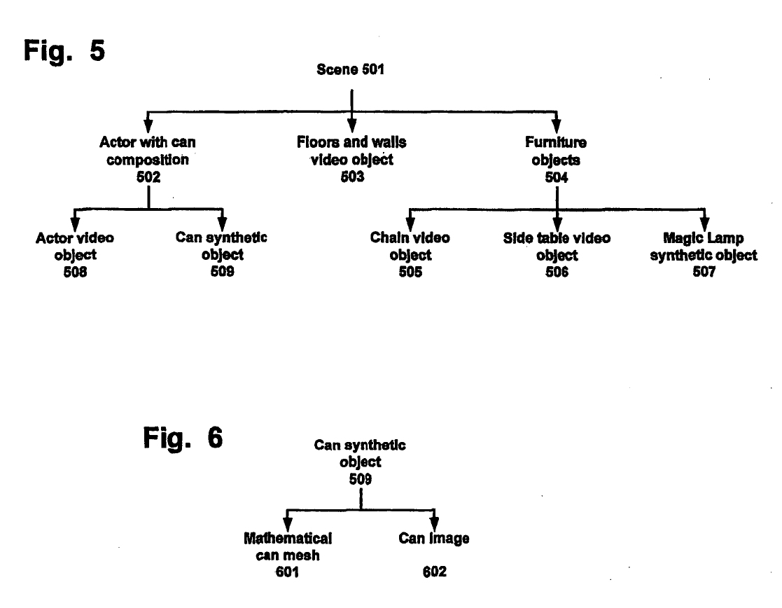

Referring now to FIG. 5, a representative scene 501 may comprise a composition of an actor holding a can 502, within a setting video object of floors and walls 503 filled with furniture objects 504. In this example, furniture objects may comprise a real video object chair 505, a real video object side table 506, and a synthetic animated object magic lamp 507. Actor composition 502 may further comprise a real video object actor 508 and a synthetic computer generated can 509.

In terms of editing, the strength of the object-oriented representation in MPEG-4 is that audio and visual elements may be easily and independently manipulated. The equivalents of paint 110, montage 111 and animation 112 as illustrated in FIG. 1 are executed in MPEG-4 by performing operations on visual objects. Similarly, equivalents to audio editing of speech 105, sound 106 and music 107 as illustrated in FIG. 1 are executed in MPEG-4 by performing operations on audio objects.

Representation of visual objects in MPEG-4 may be further accomplished by mapping images onto computer generated shapes. This method, combining aspects of paint 110, montage 111 and animation 112, comprises creating a mathematical model of the object in the form of a line-drawing “wire-frame” or “mesh” representing the general object in space and then using algorithms well known in the art of computer animation to map images onto the mesh, thereby creating an “instantiation” of the object. In principal, any mesh may have any image mapped onto it. Such a computer generated synthetic object may, in turn, be grouped with other objects to form a composite object within a composition.

Referring now to FIG. 6, synthetic computer generated can 509 from FIG. 5 further comprises a computer generated mathematical model can mesh 601 and a can image 602 mapped onto mesh 601. Can image 602 may be purely synthetic animation, or in the alternative it may be video content representing a real can. In either case, as will be appreciated by those skilled in the art, the item which can object 509 represents may be easily replaced simply by replacing can image 602 with another image. By employing such a technique, an MPEG-4 editor may replace and substitute items in visual content with relative ease.

The ability easily to replace items in moving content, as described hereinabove, enables the present invention. Simply put, the present invention comprises a system of replacing commercial items in moving content with other items. Such virtual product placement enables new and useful ways of doing business related thereto.

As will be appreciated by those skilled in the art, and advantageously for the present invention, the foregoing editing techniques may be applied to works in various stages of production, including post-production. Existing finished works may be modified to yield new versions with the content changed as desired. A simple embodiment of the present invention would entail the modification of a work to include the placement of a desired product. Such product placement could occur serially as well, with successive versions of a work containing different product placements. In the alternative, beginning with the same content, several contemporaneous versions of original moving content may be created, different versions containing placement of different products therein.

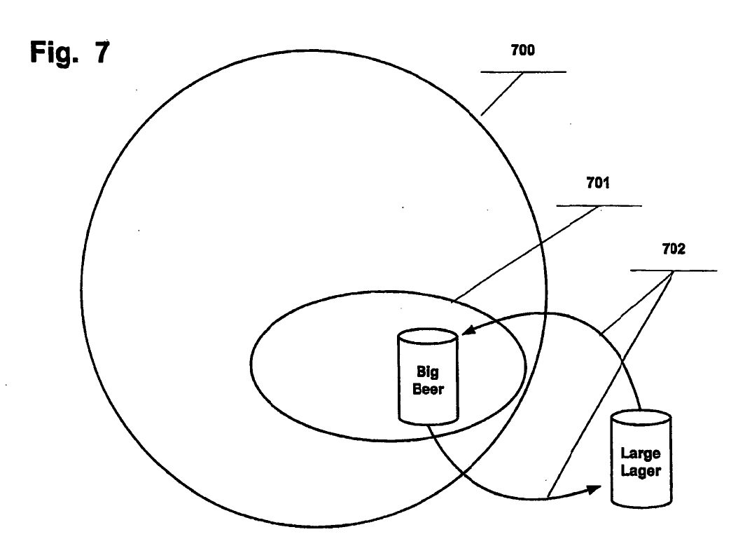

Exemplary of the present invention, referring now to FIG. 7, suppose that scene 701 is a portion of valuable moving content 700, such as a popular motion picture or video game. Suppose further that, contextually, can 703 is a can of beer. The identity of the brand of beer can 703 has value as product placement within the moving content 700. In the prior art, the identity of the brand of beer can 703 would be fixed by the actual can of beer used in production and its value as product placement would therefore be limited to that single brand. According to the teaching of the present invention, however, the brand identity of beer can 703 may be modified to suit various business needs.

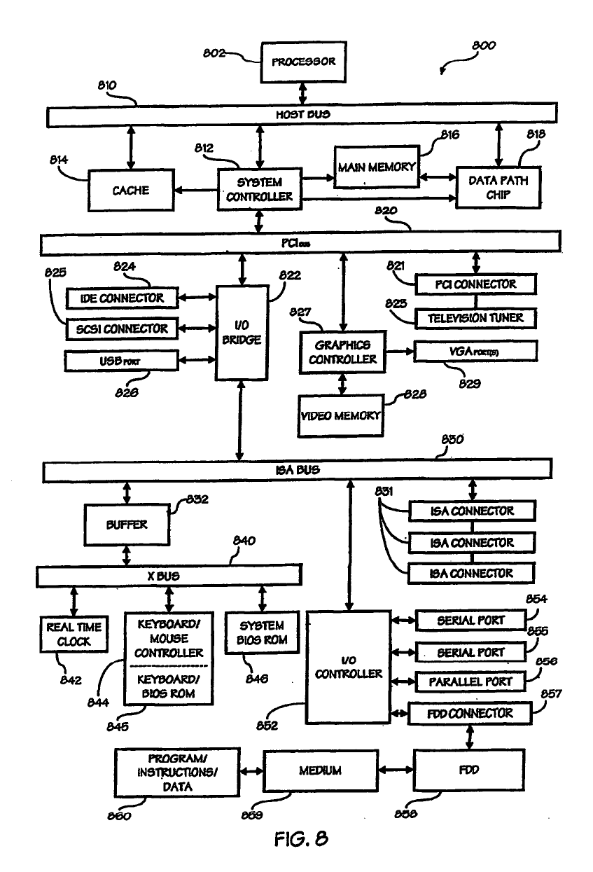

Digital editing 100 and manipulation of MPEG-4 compositions 501 are accomplished by an information handling system, preferably a general purpose computer. Referring to FIG. 8, a block diagram of an exemplary information handling system 800 operable to employ the present invention is shown. In this embodiment, processor 802, system controller 812, cache 814, and data-path chip 818 are each coupled to host bus 810. Processor 802 is a microprocessor such as a 486-type chip, a Pentium7, Pentium II7, Pentium III7 or other suitable microprocessor. Cache 814 provides high-speed local-memory data (in one embodiment, for example, 512 KB of data) for processor 802, and is controlled by system controller 812, which loads cache 814 with data that is expected to be used soon after the data is placed in cache 812 (i.e., in the near future). Main memory 816 is coupled between system controller 814 and data-path chip 818, and in one embodiment, provides random-access memory of between 16 MB and 128 MB of data. In one embodiment, main memory 816 is provided on SIMMS (Single In-line Memory Modules), while in another embodiment, main memory 816 is provided on DIMMs (Dual In-line Memory Modules), each of which plugs into suitable sockets provided on a motherboard holding many of the other components shown in FIG. 8. Main memory 816 includes standard DRAM (Dynamic Random-Access Memory), EDO (Extended Data Out) DRAM, SDRAM (Synchronous DRAM), or other suitable memory technology. System controller 812 controls PCI (Peripheral Component Interconnect) bus 820, a local bus for system 800 that provides a high-speed data path between processor 802 and various peripheral devices, such as video, disk, network, etc. Data-path chip 818 is also controlled by system controller 812 to assist in routing data between main memory 816, host bus 810, and PCI bus 820.

In one embodiment, PCI bus 820 provides a 32-bit-wide data path that runs at 33 MHZ. In another embodiment, PCI bus 820 provides a 64-bit-wide data path that runs at 33 MHZ. In yet other embodiments, PCI bus 820 provides 32-bit-wide or 64-bit-wide data paths that runs at higher speeds. In one embodiment, PCI bus 820 provides connectivity to I/O bridge 822, graphics controller 827, and one or more PCI connectors 821, each of which accepts a standard PCI card. In another embodiment, a television tuner 823 is included for viewing television signals. In yet another embodiment, I/O bridge 822 and graphics controller 827 are each integrated on the motherboard along with system controller 812, in order to avoid a board-connector-board signal-crossing interface and thus provide better speed and reliability. In the embodiment shown, graphics controller 827 is coupled to a video memory 828 (that includes memory such as DRAM, EDO DRAM, SDRAM, or VRAM (Video Random-Access Memory)), and drives VGA (Video Graphics Adaptor) port 829. VGA port 829 can connect to VGA-type or SVGA (Super VGA)-type displays. Other input/output (I/O) cards having a PCI interface can be plugged into PCI connectors 821.

In one embodiment, I/O bridge 822 is a chip that provides connection and control to one or more independent IDE connectors 824-825, to a USB (Universal Serial Bus) port 826, and to ISA (Industry Standard Architecture) bus 830. In this embodiment, IDE connector 824 provides connectivity for up to two standard IDE-type devices such as hard disk drives, CDROM (Compact Disk-Read-Only Memory) drives, DVD (Digital Video Disk) drives, or TBU (Tape-Backup Unit) devices. In one similar embodiment, two IDE connectors 824 are provided, and each provide the EIDE (Enhanced IDE) architecture. In the embodiment shown, SCSI (Small Computer System Interface) connector 825 provides connectivity for up to seven or fifteen SCSI-type devices (depending on the version of SCSI supported by the embodiment). In one embodiment, I/O bridge 822 provides ISA bus 830 having one or more ISA connectors 831 (in one embodiment, three connectors are provided). In one embodiment, ISA bus 830 is coupled to I/O controller 852, which in turn provides connections to two serial ports 854 and 855, parallel port 856, and FDD (Floppy-Disk Drive) connector 857. In one embodiment, FDD connector 857 is connected to FDD 858 that receives removable media (floppy diskette) 859 on which is stored data and/or program code 860. In one such embodiment, program code 860 includes code that controls programmable system 800 to perform the method described below. In another such embodiment, serial port 854 is connectable to a computer network such as the Internet, and such network has program code 860 that controls programmable system 800 to perform the method described below. In one embodiment, ISA bus 830 is connected to buffer 832, which is connected to X bus 840, which provides connections to real-time clock 842, keyboard/mouse controller 844 and keyboard BIOS ROM (Basic Input/Output System Read-Only Memory) 845, and to system BIOS ROM 846.

By means of techniques such as paint 110, montage 111 and animation 112 (FIG. 1), or by substituting a can image 602 (FIG. 6) in MPEG-4, referring back to FIG. 7, the identity of beer can 703 is modified 702 for branding.

In a very simple embodiment, the brand identity of beer can 703 may be sold to an interested party. Beer can 703 is modified 702 to brand the beer can according to the desires of the interested party. The moving content 700 containing scene 701 with branded beer can 703 is then distributed to the public.

In another embodiment, the brand identity of an item may be sold to an interested party according to time of distribution of the moving content. By way of example, consider the case where the moving content 700 is a motion picture with a time limited distribution run. The distribution run may be divided into a number of time slots. Within each time slot, an interested party may purchase product placement.

Referring now to TABLE 1, a six week distribution run of a motion picture is represented incorporating beer can 703. As shown, the brand identity of beer can 703 is divided into weekly time slots, each of which has been sold to an interested party and defined accordingly. Brand names are used solely for the purpose of example.

According to this embodiment, distribution of these versions of the motion picture is controlled so that the appropriate brand is displayed for the appropriate distribution week, in accordance with the schedule set forth in Table 1.

TABLE 1
EXEMPLARY TIME SLOTS FOR PRODUCT PLACEMENT

| Distribution Week | Brand |
|---|---|
| week 1 | Budweiser |
| week 2 | Coors |
| week 3 | Coors |
| week 4 | Miller's |
| week 5 | Budweiser |
| week 6 | Samuel Adams |

As will be appreciated by those skilled in the art, different time slots may have different value, based in part upon the anticipated variation in box office receipts (corresponding to viewership) over the distribution run.

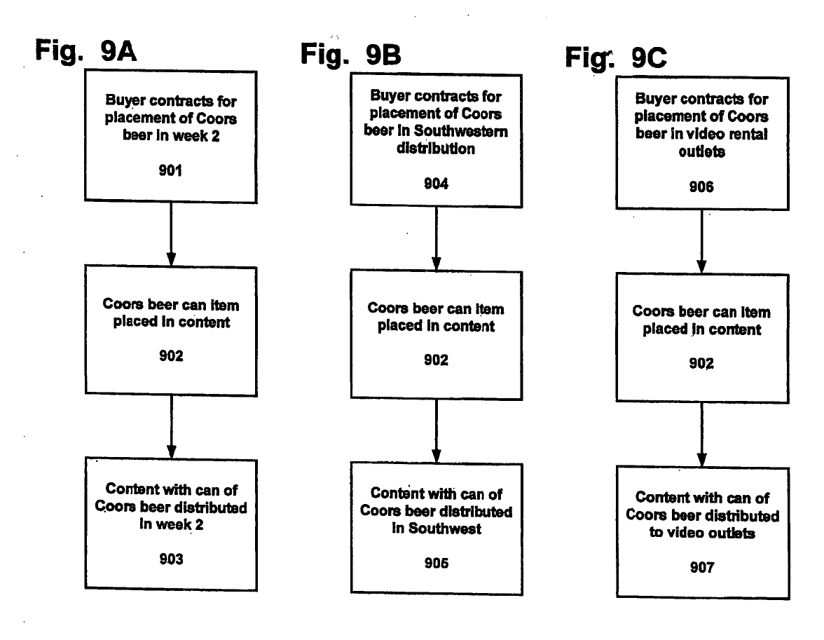

Referring now to FIG. 9A, an exemplary block diagram of this embodiment is shown. A contract is formed 901 for product placement, in this example Coors beer, in existing content for distribution in a particular week, in this example in week 2. Subsequently, by techniques known in the art as illustrated in FIG. 7, a product item, in this example a can of Coors beer, is placed 902 in the content. When the contracted time for distribution arrives, in this example week 2, the content with the placed object is distributed 903.

In another embodiment, the brand identity of an item may be sold to an interested party according to geographic territory of distribution. By way of example, consider the case where the moving content 700 is a video game to be distributed world-wide in different versions. The moving content 700 is produced in several different versions, each targeted for a particular geographic area of distribution. An interested party may buy product placement for the version of the game for a particular geographic area.

Referring now to TABLE 2, the geographic distribution is shown of versions of a video game incorporating beer can 703. As shown, the brand identity of beer can 703 depends upon geographic distribution version, each of which has been sold to an interested party and defined accordingly. Again, brand names are used solely for the purpose of example.

TABLE 2
EXEMPLARY GEOGRAPHIC VERSIONS
FOR PRODUCT PLACEMENT

| Intended Distribution | Brand |
|---|---|
| North America Midwest | Budweiser |
| North America Southwest | Coors |
| Japan | Asahi |
| United Kingdom | Guiness |
| Continental Europe | Heineken |

Referring now to FIG. 9B, an exemplary block diagram of this embodiment is shown. A contract is formed 904 for product placement, in this example also Coors beer, in existing content for distribution to a particular geographic area, in this example to Southwestern North America. Subsequently, by techniques known in the art as illustrated in FIG. 7, the product item, in this example a can of Coors beer, is placed 902 in the content. The content with the placed product is then distributed 905 to the contracted area, in this example Southwestern North America.

In yet another embodiment, the brand identity of an item may be sold to an interested party according the distribution channel of the moving content. By way of example, suppose that moving content 700 is a motion picture that will be distributed through theaters, through video rentals and through cable broadcast. Versions of content 700 for each of these channels may have different branding for beer can 703, as illustrated in Table 3.

TABLE 3
EXEMPLARY PRODUCT PLACEMENT BY CHANNEL

| Intended Distribution Channel | Brand |
|---|---|
| Cable | Budweiser |
| Video Rental | Coors |
| Theaters | Anchor Steam |

As will be appreciated by those skilled in the art, different distribution channels may have different values for product placement, and so would be priced accordingly.

Referring now to FIG. 9C, an exemplary block diagram of this embodiment is shown. A contract is formed 906 for product placement, Coors beer in this example as well, in existing content for distribution through a particular channel, in this example to video rental outlets. Subsequently, by techniques known in the art as illustrated in FIG. 7, a product item, in this case Coors beer, is placed 902 in the content. The content with the placed product is then distributed 907 through the contracted distribution channel, in this case video rental outlets.

As will be further appreciated by those skilled in the art, combinations of the foregoing embodiments are possible, wherein product placement and pricing therefor vary according to combinations of time, geographical distribution and/or distribution channel.

Although the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

1. A removable moving media, comprising:
a source content comprising motion picture or television content;
a removable content disposed at a position within the source content for providing a virtual product location; and
a communication assembly in communication with a virtual product source providing a virtual product, the communication assembly providing access to the source content and the removable content,
wherein the communication assembly allows the virtual product source to place the virtual product within the removable moving media through utilization of the removable content disposed within the source content;
wherein the communication assembly allows the virtual product source to update the position of the virtual product location in the removable moving media through repositioning of the removable content relative to the source content.

2. The removable moving media of claim 1, wherein the source content is at least one of a streaming video, a film, a video stream, and a video file format.

3. The removable moving media of claim 1, wherein the source content is a digital source content.

4. The removable moving media of claim 1, wherein the virtual product is placed within the removable moving media through at least one of a paint, a montage, an animation, and an instantiation process.

5. The removable moving media of claim 1, wherein the virtual product comprises packaging containing a consumable product.

6. The removable moving media of claim 5, wherein the virtual product is a can of beer.

7. The removable maying media of claim 1, wherein the position of the removable content in the source content is updated through repositioning without changing the virtual product in the virtual product location.

8. The removable moving media of claim 1, wherein the commercial item of the virtual product is an actual image of the virtual product.

9. A system for placing virtual products within a moving media of motion picture or television content, comprising:
an original moving media content source including a removable content, the removable content providing a virtual product location at a position in the moving media;
a network in communication with the original moving media content source, the network providing a virtual product source; and
a virtual product disposed within the virtual product source, the virtual product being an image of an item enabled for placement in the virtual product location of the removable content, the virtual product being enabled for updating the position of the virtual product location of the removable content in the moving media,
wherein the virtual product is downloaded from the network, and placed on the moving media in the virtual product location; and
wherein the virtual product is updated on the moving media in the virtual product location, and the position of the virtual product location relative to the moving media is updated.

10. The system of claim 9, wherein the network includes at least one of a website on a network and a peripheral computing system.

11. The system of claim 9, wherein the virtual product source updates the virtual product location on the removable content within the original moving media content source.

12. The system of claim 9, wherein the original moving media content source is at least one of a streaming video, a film, a video stream, and a video file format.

13. The system of claim 9, wherein the original moving media content source is a digital source content.

14. The system of claim 9, wherein the virtual product is placed within the virtual product location through at least one of a paint, a montage, an animation, and an instantiation process.

15. The removable moving media of claim 9, wherein the virtual product comprises packaging containing a consumable product.

16. A digital source content, comprising:
a source content including a motion picture;
a removable content disposed at a position within the source content for providing a virtual product location; and
a communication assembly in communication with a virtual product source providing a virtual product, the communication assembly providing access to the source content and the removable content,
wherein the communication assembly allows the virtual product source to place the virtual product within the removable moving media through utilization of the removable content disposed within the source content;
wherein the communication assembly allows the virtual product source to update the position of the virtual product location in the removable moving media through repositioning of the removable content relative to the source content.

17. The digital source content of claim 17, wherein the virtual product comprises packaging containing a consumable product.

18. A removable moving media, comprising:
a source content adhering to an MPEG-4 format and comprising motion picture or television content;
a removable content disposed at a position within the source content for providing a virtual product location; and
a communication assembly in communication with a virtual product source providing a virtual product, the communication assembly providing access to the source content and the removable content,
wherein the communication assembly allows the virtual product source to place the virtual product within the removable moving media, via an instantiation of the virtual product, through utilization of the removable content disposed within the source content; and
wherein the virtual product source updates the position of the virtual product location in the removable moving media through repositioning of the removable content relative to the source content; and
wherein the position of the removable content in the source content is updated through repositioning without changing the virtual product in the virtual product location.

19. A method of positioning a virtual product in removable moving media comprising motion picture or television content, the method comprising:
providing a source content with a removable content disposed at a position within the source content, the removable content defining a virtual product location in the source content;
providing a virtual product by a virtual product source through a communication assembly which provides access to the source content and the removable content;
placing the virtual product in the removable moving media using the removable content disposed within the source content; and
updating the position of the virtual product location in the removable moving media by repositioning the removable content relative to the source content.
